(19) United States
(12) Patent Application Publication
(10) Pub. No.: US 2011/0274228 A1
(43) Pub. Date: Nov. 10, 2011

(54) NUCLEAR FUSION USING ELECTROSTATIC CAGE AND ELECTRO-MAGNETIC FIELD

(76) Inventor: Jose E. LOPEZ, Sunnyvale, CA (US)

(21) Appl. No.: 12/773,732

(22) Filed: May 4, 2010

(51) Int. Cl. G21B 1/00

(52) U.S. Cl. 376/146

(57) ABSTRACT

An apparatus for generating power includes a cage having a plurality of elongated elements defining a space within the cage, wherein the space has a region for allowing ion collision to occur, and a pair of electromagnets located at or near respective opposite ends of the cage. An apparatus for generating power includes a vacuum chamber, a first solenoid, a second solenoid, wherein the first and the second solenoids are located on opposite sides of the vacuum chamber, and a coupler that mechanically couples the first solenoid to the second solenoid, wherein the coupler has an end defining an opening that resembles a dumbbell shape.

### FIELD

This application relates generally to devices and methods for generating energy, and more specifically, to devices and methods for generating energy using nuclear fusion.

### BACKGROUND

Fossil fuel burning and nuclear fission systems have been used to generate energy. However, such energy systems are of limited fuel supply and they produce contaminants and pollution that are harmful to the environment and humans.

Nuclear fusion is the process by which multiple like-charged particles (e.g., atomic nuclei) collide and join together. It is accompanied by the release of energy. Fusion has been used as an explosive weapon but has not been proven practical for a cheaper, cleaner and more reliable energy source. It is very difficult to achieve net energy gain where the energy fed into the machine is less than the energy caused by nuclear fusion.

In some existing fusion machines, positive ions are accelerated toward a negatively biased center grid. Ions collide inside the grid, and therefore create fusion. However, such machines lose positively charged ions due to collisions with the negative grid. They also lose energy because as ions move one-way (e.g, toward the center grid) electrons move the other way (e.g. away from the grid) causing velocity loss due to mutual attraction. In addition the angles in which collisions occur are random instead of head-on where the chances of fusion are better.

In other machines positive ions and electrons are confined in a toroidal magnetic field and then heated. The resulting ion collisions due to the elevated temperature may create fusion but heating also forces the ion plasma to expand and therefore lose density, which is detrimental to increasing the rate of fusion.

Furthermore in other fusion machines, multiple identical laser beams fire an extremely precise symmetrical pulse merging onto a very small pellet of frozen deuterium fuel. This method has the disadvantage of not having sufficient distance necessary to efficiently accelerate the fuel to velocities that will create fusion. In addition, if there should be any imperfections in the system's symmetry and timing of pulse, the laser energy will vent out to a weak spot, resulting in the loss of compression pressure.

Applicant of the subject application determines that it may be desirable to have improved fusion systems and methods. Applicant of the subject application also determines that it may be desirable to have a fusion system and method that assist in increasing the velocity of the traveling ions in a confined rotation path, merging the ions to a head-on collision, recycling non-fused ions back into the collision path increasing the ion density for collision per unit time, preventing positive ions from colliding with a negatively charged component, separating positive and negatively charged particle paths to minimize mutual deceleration, and/or tuning the frequency of the colliding ion particle waves so they resonate at the area of collision. Applicant also determines that it may be desirable to have a fusion system and method that assist the ion particles in preserving their velocities for the next pass should they miss each other, and orienting the colliding ion particles so that their positive charge ends are away from each other to minimize the Coulomb barrier. Any one or combination of the above features would allow energy to be more efficiently created from the fusion process.

### SUMMARY

In accordance with some embodiments, an apparatus for generating power includes a cage having a plurality of elongated elements defining a space within the cage, wherein the space has a region for allowing ion collision to occur, and a pair of electromagnets located at or near respective opposite ends of the cage.

In accordance with other embodiments, an apparatus for generating power includes a cage having opposite ends and at least six elongated elements extending between the opposite ends, the at least six elongated elements defining a space within the cage, wherein the space has a first region for allowing ions to move in a first circular path, and a second region for allowing additional ions to move in a second circular path.

In accordance with other embodiments, an apparatus for generating power includes a vacuum chamber, a first solenoid, a second solenoid, wherein the first and the second solenoids are located on opposite sides of the vacuum chamber, and a coupler that mechanically couples the first solenoid to the second solenoid, wherein the coupler has an end defining an opening that resembles a dumbbell shape.

In accordance with other embodiments, an apparatus for generating power includes a vacuum chamber, a first solenoid, a second solenoid, wherein the first and the second solenoids are located on opposite sides of the vacuum chamber, and both solenoids have an inner core that resembles a dumbbell shape with a relatively lower electromagnetic permeability than the outer core, and a coupler that mechanically couples the first solenoid to the second solenoid, wherein the coupler has an end defining an opening that resembles a dumbbell shape.

Other and further aspects and features will be evident from reading the following detailed description of the embodiments, which are intended to illustrate, not limit, the invention.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates a system for generating energy using fusion in accordance with some embodiments;

FIG. 2 illustrates some components of the system of FIG. 1 in accordance with some embodiments;

FIG. 3 illustrates an example of the dimensions of the cage elements of the system of FIG. 1 in accordance with some embodiments;

FIG. 4 illustrates some components of the system of FIG. 1 in accordance with some embodiments;

FIG. 5 illustrates an end view of a coupling mechanism that couples to two solenoids in the system of FIG. 1 in accordance with some embodiments;

FIG. 6A illustrates an ion collision path in the system of FIG. 1 in accordance with some embodiments;

FIG. 6B illustrates ion path fluctuation in accordance with some embodiments;

FIG. 7 illustrates another system for generating energy using fusion in accordance with other embodiments;

FIG. 8 illustrates some components of the system of FIG. 7 in accordance with some embodiments;

FIG. 9 illustrates an end view of a portion of the system of FIG. 7 in accordance with some embodiments;

FIG. 10 illustrates an example of the dimensions of the cage elements of the system of FIG. 7 in accordance with some embodiments;

FIG. 11 illustrates a pair of magnetic mirrors of the system of FIG. 7 in accordance with some embodiments;

FIG. 12 illustrates an ionizer of the system of FIG. 7 in accordance with some embodiments;

FIG. 13 illustrates the gas supply of the system of FIG. 7 in accordance with some embodiments;

FIG. 14 illustrates an energy collector of the system of FIG. 7 in accordance with some embodiments;

FIG. 15A illustrates an ion collision path in the system of FIG. 7 in accordance with some embodiments;

FIG. 15B illustrates ion path fluctuation in accordance with some embodiments; and

FIG. 16 illustrates a block diagram of the system of FIG. 7 in accordance with some embodiments.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment does not need to have all the aspects or advantages shown. An aspect or an advantage described in conjunction with a particular embodiment is not necessarily limited to that embodiment and can be practiced in any other embodiments even if not so illustrated.

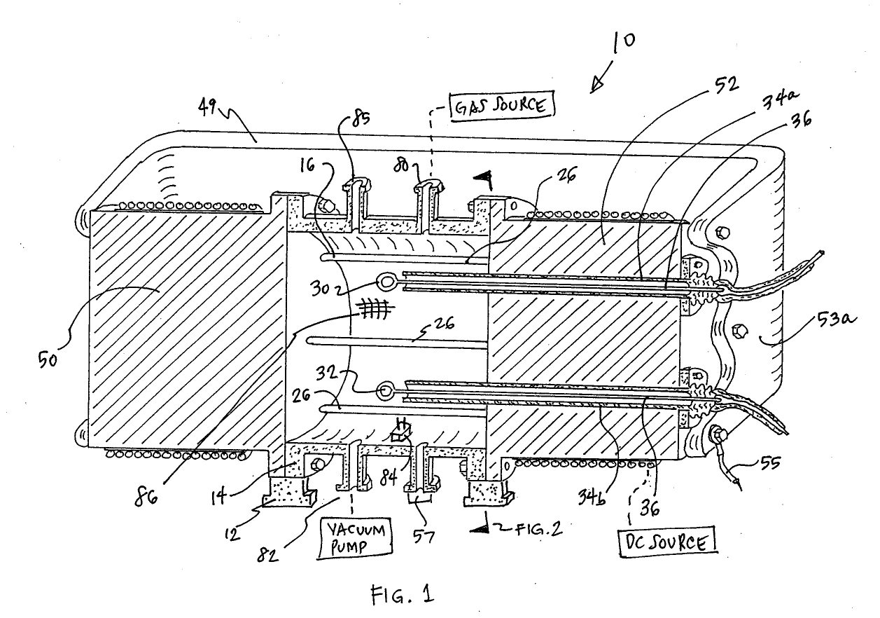

FIG. 1 illustrates a system 10 for generating power using fusion in accordance with some embodiments. The system 10 is illustrated in a cross-sectional view. Thus, it should be understood that the complete system 10 would include similar components that are the mirror image of those illustrated in the figure. As shown in the figure, the system 10 includes a support 12, a vacuum chamber 14 coupled to the support 12, and a cage 16. The cage 16 is not limited to the configuration shown, and may have other configurations (e.g., shapes) in other embodiments. The system 10 further includes a solenoid assembly 49 having a first solenoid 50, a second solenoid 52, and a coupler 53 attached to the solenoids 50, 52. The cage 16 is supported between the solenoids 50, 52. In the illustrated embodiments, the solenoids 50, 52 are electromagnets. In other embodiments, they may be permanent magnets. The electromagnets 50, 52 have the same configuration e.g. core cross section diameter, core length, magnetic core metal, number of wire turns, direction of turn, direction of current, wire size and insulation, The solenoids 50, 52 define part of the chamber 14. In other embodiments, the solenoids 50, 52 do not define part of the chamber 14. In such cases, the solenoids 50, 52 may be located outside the chamber 14, and may be coupled to the components that define the chamber 14. In some embodiments, the vacuum chamber 14 itself and/or the solenoid assembly 49 may be considered a support for the cage 16. In the illustrated embodiments, the system 10 further includes conductors 55 electrically connected to the corner of coupler 53, and is electrically interconnected to positively charge and ground the cage 16, solenoids 50, 52, vacuum chamber 14 and coupler 53, during use.

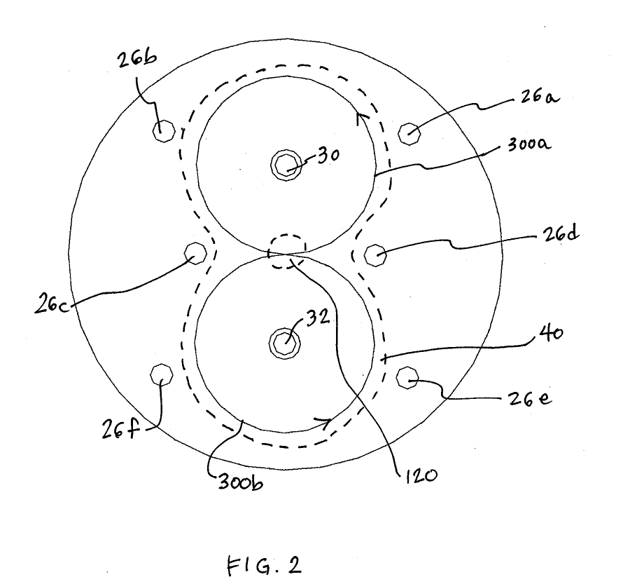

As shown in the figure, the cage 16 includes a plurality of rectilinear members 26. As shown in FIG. 2, the members 26 define a space 40 that has a region for allowing ion recirculation and collision to occur. In the illustrated embodiments, the rectilinear members 26 may be made from 316 stainless steel non-magnetic rods 1 cm. in diameter or as tubes for coolant passages that go though solenoids 50, 52. In other embodiments, the non-magnetic rods or tubes may have other cross sectional diameters or non-magnetic materials. In the illustrated embodiments, the cage 16 includes six members 26, which collectively define the space 40 that resembles a dumbbell shape. The dumbbell shape allows two ion paths 300a, 300b to occur therein. In other embodiments, the cage 16 may include more or less than six members 26. Also, in other embodiments, the members 26 may be curvilinear. The cage 16 is configured to provide an electrostatic confinement for the ions in the space 40.

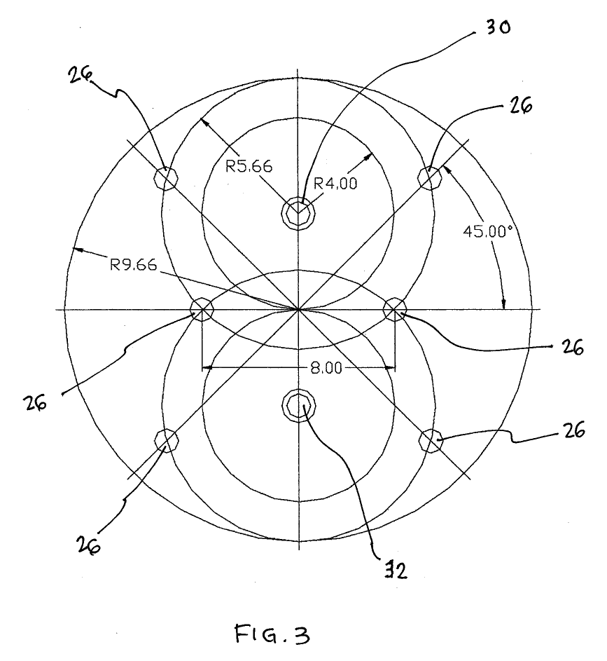

FIG. 3 illustrates an example of some of the dimensions that may be used for the cage 16. The dimensions in the figure are in centimeters. It should be noted that the dimensions for the cage 16 (and the system 10) may be different in different embodiments. For example, in some embodiments, the system 10 may be of a size of a building. In other embodiments, the system 10 may have a hand-held size. Thus, the system 10 may be scaled to be larger (to allow more ion in the fusion space) or smaller (to allow less ion in the fusion space), depending on the specific need of the application. In some cases, the radius of rotation for the ions or electrons due to the solenoids 49 may be determined as r=mv/qB, where m is the mass of a charge particle, v is the velocity of the particle to achieve fusion, q is a charge of the particle, and B is a magnetic field value. Also, in some embodiments, the dimension of the system 10 may depend on the ions being used. For example, the dimensions for the system 10 may be smaller if deuterium ions are used compared to if Boron₁₁ are used.

As shown in FIG. 1, the system 10 also includes two nodes (electrodes) 30, 32 that are supported by respective support members 34a, 34b extending through the solenoid 52. The nodes 30, 32 are configured to center ion rotation during use. In some embodiments, each of the two nodes 30, 32 may be in the form of a spherical cage made from 316 stainless steel non-magnetic wire 0.0625″ in diameter. In some embodiments, each of the two nodes 30, 32 may be a negatively charged cage that is 1.0 cm in diameter. Each support member 34 includes a conductor 36 for supplying a current to charge the nodes 30, 32 during use. The support member 34a/34b surrounding the conductor 36 is made from an electrically insulative material, such as a ceramic. As shown in FIG. 2, the two nodes 30, 32 are located inside the space 40 defined by the cage 16. During use, the two nodes 30, 32 are negatively charged while the cage 16 is positively charged.

As shown in the figure, the cage 16 and the nodes 30, 32 are enclosed in the vacuum chamber 14 to reduce ion losses. The vacuum chamber 14 also improves fusion efficiency since air has atoms and molecules that may get in the way of ion collisions and also cause Paschen discharge losses.

In the illustrated embodiments, the system 10 also includes an in-port 80 for supplying fuel gas inside the vacuum chamber 14, an out-port 82 for removing by-product gas that resulted from nuclear fusion and for maintaining vacuum, an ionizer 84 for creating ions inside the vacuum chamber 14, and an energy collector 86 for collecting energy resulted from nuclear fusion that occurs inside the vacuum chamber 14. The energy collector 86 (a portion of which is illustrated) may be implemented using a grid that is placed next to the interior wall of the chamber 14. In other embodiments, the grid may be placed outside the chamber 14. Also, in other embodiments, the energy collector 86 may be implemented using other devices known in the art. The system 10 may optionally also include a view port 85 for allowing a user to install a camera and see inside the vacuum chamber 14 and observe the rate of fusion. System 10 may also include a vacuum gage 57 to monitor the vacuum air pressure.

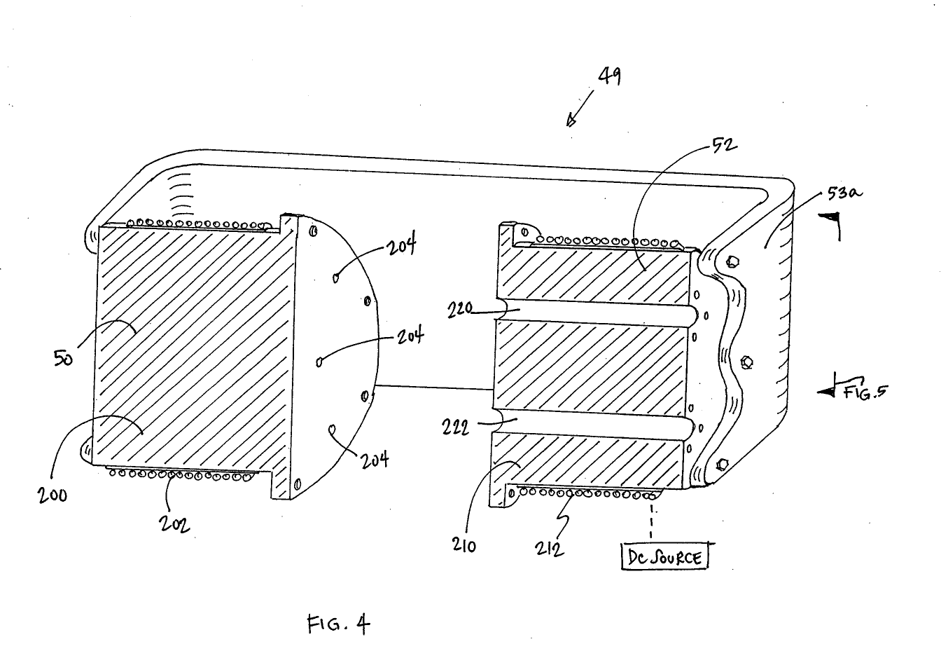

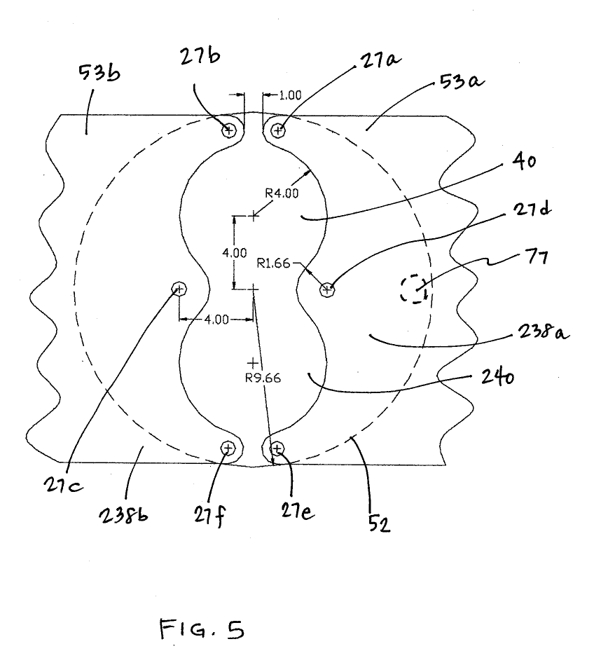

FIGS. 4 and 5 illustrate the solenoid assembly 49 in further detail. The solenoid assembly 49 includes solenoids 50, 52. The solenoid 50 includes a metallic core 200 surrounded by a coil 202. Similarly, the solenoid 52 includes a metallic core 210 surrounded by a coil 212. The cores 200, 210 and couplers 53a, 53b may be made from steel, iron, or other magnetic or magnetizable materials. The solenoid 50 includes a plurality of openings 204 for allowing the cage elements 26 to couple thereto. The solenoid 52 also includes similar openings (not shown). The solenoid 52 also includes two channels 220, 222 for accommodating components that couple to the electrodes 30, 32. In the illustrated embodiments, the solenoids 50, 52 are coupled to a DC source during use, which provides currents to the coils 202, 212 to thereby create electromagnetic fields. In other embodiments, the solenoids 50, 52 may be coupled to respective DC sources. Coils 202 and 212 are wound in the same direction thereby creating a magnetic field wherein the facing ends of solenoids 50, 52 are opposite poles (e.g. N/S or S/N) within vacuum chamber 14. In addition, vacuum chamber 14 along with ports 80, 85, 82, 57, ionizer 84, energy collector 86 and cage 16 are all made of non-magnetic materials such as non-magnetic stainless steel so as not to interfere with the magnetic field flow between the facing ends of solenoids 50, 52. In the illustrated embodiments, the solenoids are placed at the opposite ends of the cage 16. In other embodiments, the solenoids may be placed near the ends of the cage 16. In some embodiments, the solenoid is considered near an end of the cage 16 if it is located within 30% of the width of the cage 16 measured from the end of the cage 16. In some embodiments, the solenoids 50, 52 may be implemented using Helmholtz coil electromagnets.

As shown in FIGS. 4 and 5, the solenoids 50, 52 are coupled together by couplers 53a, 53b. The couplers 53a, 53b are configured to-induce the magnetic field flux through the chamber 14 that contains the cage 16, so that substantially all (e.g., 90% or more) of the magnetic field flux extends directly between solenoids 50, 52. This way, most of the magnetic field flux will not flow directly between the opposing ends of solenoid 50, also most of the magnetic field flux will not flow directly between opposing ends of solenoid 52. As shown in FIG. 5, the couplers 53a, 53b have ends 238a, 238b secured by steel bolts, wherein the bolts 27a-27f cooperatively form an opening 240 having a dumbbell shape. The dumbbell shape of the opening 240 corresponds with the ion paths 300a, 300b, and results in magnetic field flux being directed through the chamber 14, wherein the magnetic field flux also corresponds with the ion paths 300a, 300b. In the illustrated embodiments, the end 238a of the coupler 53a is configured such that the distance between bolt 27a location at the outer end of solenoid 52 through the coupler 53a and the corresponding bolt location at the outer end of solenoid 50, is more than the distance between point 77 at the outer end of solenoid 52 through coupler 53a to the corresponding point at the outer end of solenoid 50. This is also true in the comparison between bolt 27e location and point 77 at the end of solenoid 52 to their corresponding points at the end of solenoid 50. These differences in distance would result in an increased concentration of magnetic flux around the area between point 77 and bolt 27d, since the magnetic field will tend to follow the path with the least distance. These differences in magnetic flux concentration are also true for the symmetrical side involving coupler 53b and the end 238b. This, together with the dumbbell shaped opening 240 created by ends 238a, 238b of the couplers 53a, 53b, assists in creating the ion paths 300a, 300b. Although only a pair of ends 238a, 238b is illustrated in the figure, it should be understood that the solenoid assembly 49 also includes a same pair of ends at the opposite end of the solenoid assembly 49 (i.e., at the outer end of solenoid 50).

Furthermore, in some embodiments, to create even more variance in magnetic flux, both metallic cores 200, 210 of solenoids 50, 52 respectively could have respective inner cores with a cross section resembling the dumbbell shaped opening 240 (also the profile of space 40) that extends along the length of each metallic cores 200, 210. The inner cores have a relatively lower permeability (electromagnetism), or electromagnetic permeability, than the surrounding outer layer of the components 200, 210. These inner cores could be separately machined and inserted into a matching dumbbell shaped hole and then welded to a vacuum seal at the ends. This configuration would further assist in creating the ion paths 300a and 300b.

During use of the system 10, suction (e.g., with vacuum pressures less than 7 miilitorrs), is created within the grounded vacuum chamber 14 that houses the cage 16, and the energy collector 86. The energy collector 86 for collecting energy is positively charged (e.g. 10 to 20 kv, the same as cage 16), and the cage elements 26 of the cage 16 are high voltage positively charged (e.g., 10 to 20 kv) and grounded. The two electrodes 30, 32 within the cage 16 are high voltage negatively charged (e.g., 10 to 20 kv). The ion source 80 then injects gas into the vacuum chamber 14. The ionizer 84 applies a potential (e.g. 200 to 600 volts) between its terminals to create ions within the chamber 14.

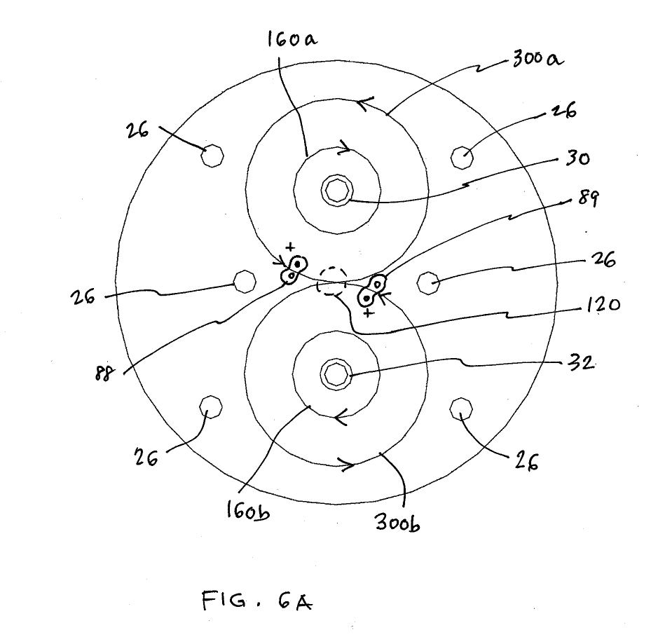

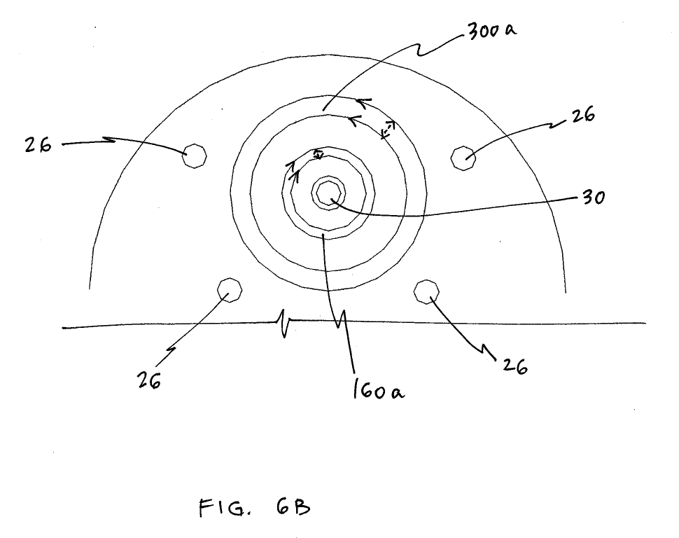

In the illustrated embodiments, the charged cage 16 and the charged electrode cages 30, 32 are used to increase ion velocity, provide ion confinement, and increase ion density, thereby focusing ion collisions to provide an ideal condition for nuclear fusion. Fluctuating DC ripple voltages are provided to the cage elements 26 and electrodes 30, 32 to thereby accelerate the ions. In some embodiments, the voltage source is configured to provide a DC ripple negative signal to electrodes 30 and 32 that fluctuates in a periodic manner (e.g., in a sinusoidal manner) between a high level (e.g., 20 kv) and a low level (e.g., 10 kv) at a certain prescribed frequency, such as 3.9 MHz. In FIG. 6A the DC ripple negative signal to electrodes 30 and 32 may fluctuate at the same frequency, amplitude and synchronization so that the resulting ion waves will resonate and not cancel each other out when they meet at the point of fusion 120 thereby preventing loss of velocity and energy. In FIG. 6A the ions at the point of fusion 120 may mainly meet with their individual concentrations of positive charge pointing inward toward their respective negative electrodes (e.g. ion 88 toward electrode 30 and ion 89 toward electrode 32) minimizing the Coulomb barrier due to having like positive charge ends away from each other when the ions 88 and 89 collide. In the case of deuterium ions 88, 89 the positive proton may mainly point toward the negative electrode and the neutron away from it.

The solenoids 50, 52 use Lorentz' right-hand rule to induce high velocity ion and electron rotation, while confining the ions within the space 40 defined by the cage elements 26. Solenoids 50 and 52 are preferred to be operated in a steady state DC signal (or alternatively, at a fluctuating DC ripple voltage) to control the rate of fusion. During high magnetic flux densities, the ions would have a smaller radius of rotation and therefore less likelihood of collisions. When the flux density lowers, the collision rate increases. In other embodiments, the energy levels may be different, and the frequency may be different from that described. The energy levels and the frequency may be selected to accelerate the ions to the velocity required to achieve fusion within space 40.

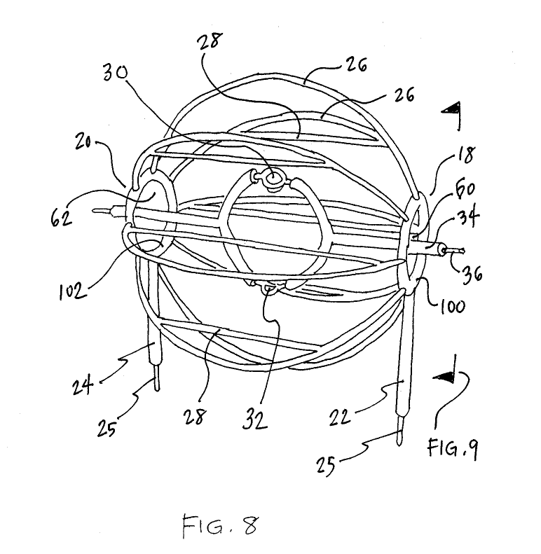

As shown FIG. 2, due to the configuration of the cage 16, the positively charged cage 16, the negatively charged nodes 30, 32, and the magnetic field provided by the solenoid assembly 49, an ion path is created that has a figure 8 shape, where the intersection is the point of fusion—e.g., region 120. In particular, the two identical solenoids 50, 52 create magnetic lines of force between them to induce ions into a circular path, resulting in confinement and rotational motion of the ions about the nodes 30, 32. The ions between the electrode 30 and the members 26a, 26b, 26c, 26d will travel in an ion path 300a, which circumscribes the negatively charged electrode 30. The positively charged members 26 around the electrode 30 assist in confining the ions within the space 40 while the ions are accelerated along the path 300a. While the positively charged ions travel around electrode 30 in one direction, electrons at electrode 30 travel along a path 160a (e.g., around the cage of the node 30) that is in the opposite direction, creating a virtual cathode that limits electron emissions from the negative cage 30 (FIG. 6A). The separate rotation radii, opposing directions and high velocities prevent the two charges from combining, but their attractions aid in mutual confinement. In some cases, the electron rotation prevents collisions with the positively charged cage 16, thereby preventing losses so that energy is saved.

Similarly, ions between the electrode 32 and the members 26c, 26d, 26e, 26f will travel in an ion path 300b, which circumscribes the negatively charged electrode 32. The positively charged members 26 around the electrode 32 assist in confining the ions within the space 40 while the ions are accelerated along the path 300b. While the positively charged ions travel around the node 32 in one direction, electrons at the node travel along a path 160b (e.g., around the cage of the node 32) that is in the opposite direction, creating a virtual cathode that limits electron emissions from the negative cage 32 (FIG. 6A). The separate rotation radii, opposing directions and high velocities prevent the two charges from combining, but their attractions aid in mutual confinement. In some cases, the electron rotation prevents collisions with the positively charged cage 16, thereby preventing losses so that energy is saved.

It should be noted that the ion paths will fluctuate due to the fluctuation of the cage's 16 DC voltage. FIG. 6B illustrates ion path fluctuation due to the cage's 16 DC voltage fluctuation. Analyzing the top half of the cage, when the ion moves from a higher to lower path due to the cage's dc voltage fluctuations, the potential energy (distance from center) decreases but the kinetic energy (speed) increases due to the inward pull. When the ion moves from lower to higher path the potential energy increases again but the kinetic energy does not decrease much because the inward force is less. The speed increases with each cycle causing the ion to spiral outward. Thus, as the DC voltage supplied to the cage 16 fluctuates, the ion path will also fluctuate within the space 40 accordingly. The electron will also accelerate when shifting from a higher to lower path but at a slower rate and is slowed down by the ion's counter-rotation. Thus, the electrons around the electrode 30 will also fluctuate due to the fluctuation of the DC voltage, as illustrated in the figure. The same condition is true with respect to the electrode 32.

As shown in FIGS. 2 and 6A, the two ion paths 300a, 300b collectively form a figure-8 shape ion path. In some cases, ions may escape from within the space 40. In such cases, the solenoid assembly 49 will assist in confining the escaped ions, and arc the ions back to the ion path 300a/300b due to the higher magnetic flux concentrations outside of space 40.

When two particles collide within the space 40, fusion occurs and energy is released. In the illustrated embodiments, the energy collector 86 is positively charged during use, and is used to capture the energy released from the fusion process. Devices and techniques for capturing energy released from fusion process are known in the art, and will not be described in further detail. In some embodiments, high energy ions in the space 40 will transfer their kinetic energy (due to the ions' velocity) to potential energy upon fusion, which potential energy is converted into electrical current with a 95% efficiency. In some cases, the system 10 may further include a vacuum pump (not shown) for removing gas that is resulted from the fusion process in the cage 16 (e.g., after the energy has been absorbed by the energy collector 86).

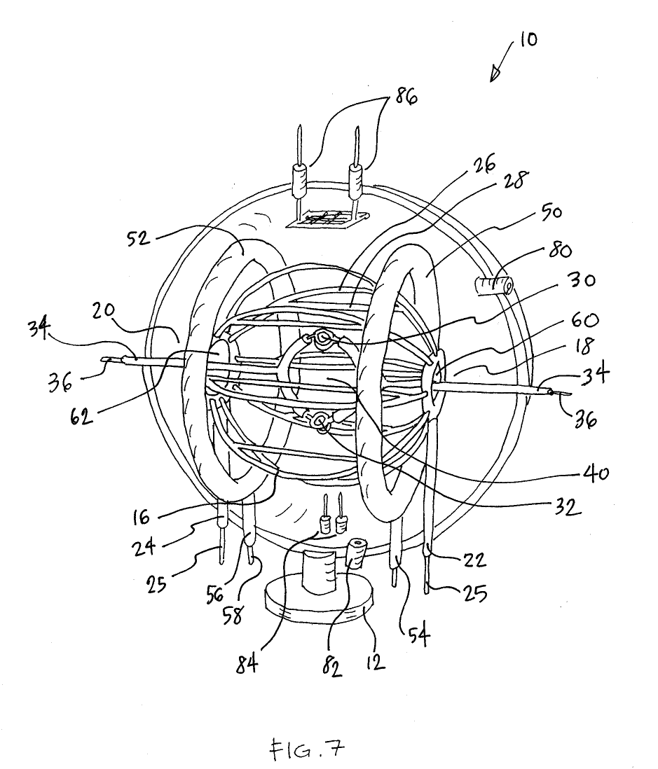

In should be noted that the system 10 is not limited to the configuration shown, and that the system 10 may have other configurations in other embodiments. FIG. 7 illustrates another system 10 for generating power using fusion in accordance with other embodiments. The system 10 includes a support 12, a vacuum chamber 14 coupled to the support 12, and a cage 16 supported in the vacuum chamber 14. The vacuum chamber 14 has a hollow spherical configuration, and is illustrated in the figure as a partial cut away view to show the internal components. In other embodiments, the vacuum chamber 14 may have other configurations (e.g., shapes). The support 12 is not limited to the shape shown, and may have other shapes and configurations in other embodiments. Also, in some embodiments, the vacuum chamber 14 itself may be considered a support for the cage 16. In the illustrated embodiments, the cage 16 has a first end 18 and a second end 20, and is fixedly secured relative to the vacuum chamber 14 at the first and second ends 18, 20 by respective support members 22, 24. The support members 22, 24 include a conductor 25, which is configured to positively charge the cage 16 during use. The support members 22,24 surrounding the conductor 25 are made from an electrically insulative material, such as a ceramic.

As shown in the figure, the cage 16 includes a plurality of curvilinear members 26, and a plurality of rectilinear members 28. The members 26, 28 define a space 40 that has a region for allowing ion collision to occur. In the illustrated embodiments, the cage 16 may be made from 316 stainless steel non-magnetic wire 0.0625″ in diameter or with tubes for coolant passages. In other embodiments, the non-magnetic wire may have other cross sectional diameters. The cage 16 will be described in further detail below.

The system 10 also includes two nodes (electrodes) 30, 32 that are coupled to support member 34, which secures the nodes 30, 32 relative to the vacuum chamber 14. The nodes 30, 32 are configured to center ion rotation during use. In some embodiments, each of the two nodes 30, 32 may be in the form of a spherical cage. In some embodiments, each of the two nodes 30, 32 may be a negatively charged cage that is 1.0 cm in diameter made from 316 stainless steel non-magnetic wire 0.0625″ in diameter. The support member 34 includes a conductor 36 for supplying a current to charge the nodes 30, 32 during use. The support member 34 surrounding the conductor 36 is made from an electrically insulative material, such as a ceramic. As shown in the figure, the two nodes 30, 32 are located inside the space 40 defined by the cage 16. The support member 34 for the nodes 30, 32 have ends that extend through respective openings 60, 62 at the ends 18, 20 of the cage 16. During use, the two nodes 30, 32 are negatively charged while the cage 16 is positively charged.

The system 10 also includes a pair of magnets 50, 52. In the illustrated embodiments, the magnets 50, 52 are electromagnets. In other embodiments, they may be permanent magnets. The electromagnets 50, 52 have the same configuration e.g. with the same overall diameter, cross section diameter, number of turns, direction of turn, direction of current, wire size and insulation, and are placed at or near opposite ends 18, 20 of the cage 16 so that the magnets form a pair of magnetic mirrors. In some embodiments, the magnet 50/52 is considered near an end of the cage 16 if it is located within 30% of the width of the cage 16 measured from the end of the cage 16. As shown in the figure, each of the magnets 50, 52 has a ring configuration, and circumscribes part of the cage 16. The magnets 50, 52 are supported inside the vacuum chamber 14 via respective support members 54, 56, and are fixed in position relative to the vacuum chamber 14. The support members 54, 56 have insulated conductors 58 within them for supplying a current to provide electromagnetic fields for the magnetic mirrors 50, 52. In some embodiments, instead of or in addition to insulating the conductors 58 within the support members 54, 56, the support members 54,56 surrounding the conductor 58 may be made from an electrically insulative material, such as a ceramic. In some embodiments, the magnets 50, 52 may be implemented using Helmholtz coil electromagnets with a uniform or near uniform magnetic field cross section within area 40.

As shown in the figure, the cage 16, the nodes 30, 32, and the magnets 50, 52 are enclosed in the vacuum chamber 14 to reduce ion losses. The vacuum chamber 14 also improves fusion efficiency since air has atoms and molecules that may get in the way of ion collisions and also cause Paschen discharge losses.

In the illustrated embodiments, the system 10 also includes an in-port 80 for supplying gas inside the vacuum chamber 14, an out-port 82 for removing by-product gas that resulted from nuclear fusion, an ionizer 84 for creating ions inside the vacuum chamber 14, and an energy collector 86 for collecting energy resulted from nuclear fusion that occurs inside the vacuum chamber 14.

Referring to FIGS. 8-10, the cage 16 will now be described in further detail. As shown in FIG. 8, the members 26, 28 of the cage 16 have elongated configurations, and extend between the ends 18, 20 of the cage 16. Each of the rectilinear cage members 28 have ends that are connected to two respective points along the length of a curvilinear member 26. The members 26 essentially define an outer cage while the members 28 (with the top and bottom most members 26) essentially define an inner cage. Thus, the cage 16 may be considered a cage assembly having inner and outer cages. The ends 18, 20 of the cage 16 include respective rings 100, 102 that define the respective openings 60, 62 for allowing the support member 34 of the nodes 30, 32 to extend therethrough.

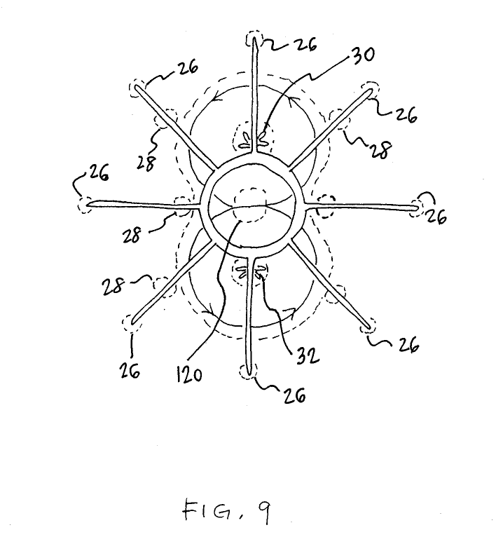

FIG. 9 illustrates an end view of some components of the system 10, particularly showing the cage elements in further detail. The cage members 26, 28 and nodes 30, 32 are represented by dashed circles. As shown in the figure, the curvilinear cage members 26 are located radially further away from the center of the cage 16 than the rectilinear cage members 28. The members 26, 28 together define the space 40 in which ions are confined. The space 40 includes a region 120 at which ion collision will take place. As shown in the figure, the space 40 defined by the members 26, 28 has a cross sectional profile that resembles a figure-8 shape. In the illustrated embodiments, the cage 16 has eight curvilinear members 26 and six rectilinear members 28. In other embodiments, the cage 16 may include other numbers of curvilinear members 26 and rectilinear members 28. Also, in further embodiments, the cage 16 may not include any curvilinear members and/or rectilinear members. Instead, the cage 16 may be formed from members with customized profile, as long as the cage 16 has a configuration for confining ions while allowing ions to travel in a figure-8 path.

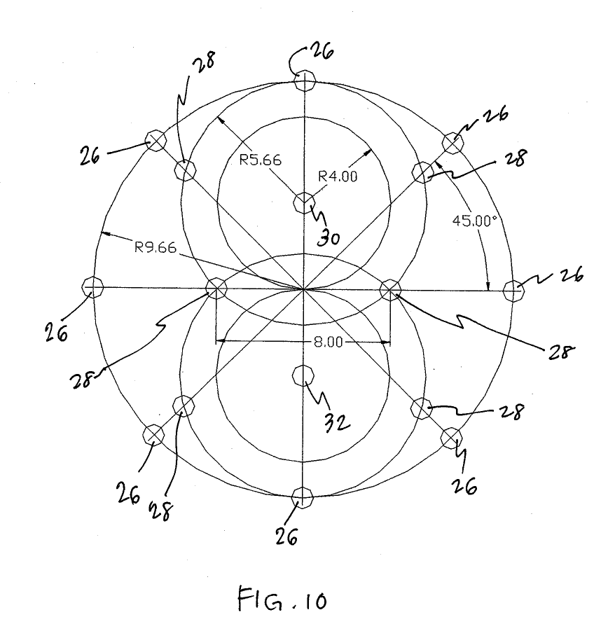

FIG. 10 illustrates an example of some of the dimensions that may be used for the cage 16. The dimensions in the figure are in centimeters. It should be noted that the dimensions for the cage 16 (and the system 10) may be different in different embodiments. For example, in some embodiments, the system 10 may be of a size of a building. In other embodiments, the system 10 may have a hand-held size. Thus, the system 10 may be scaled to be larger (to allow more ion in the fusion space) or smaller (to allow less ion in the fusion space), depending on the specific need of the application. The calculations that may be used to determine system 10's dimensions are further discussed below. Also, in some embodiments, the dimension of the system 10 may depend on the ions being used. For example, the dimensions for the system 10 may be smaller if deuterium ions are used (compared to if Boron₁₁ are used).

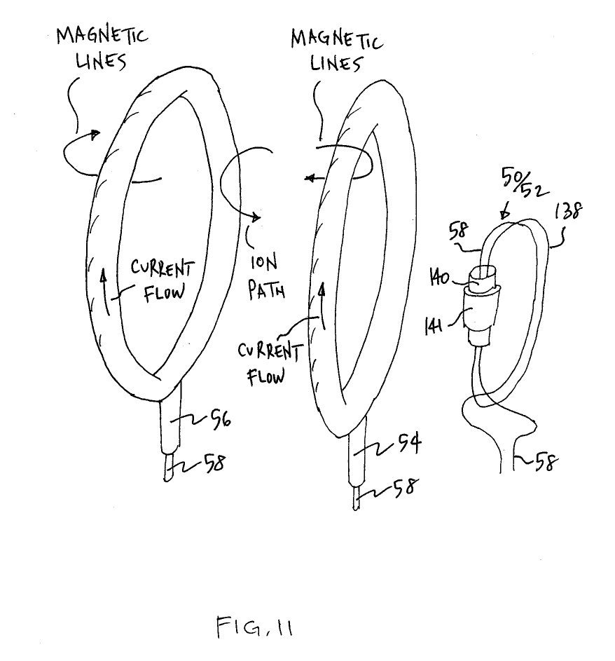

FIG. 11 illustrates the pair of magnetic mirrors 50, 52 in further detail. Each magnet 50, 52 includes a conductor 58 that forms a coil 138, and an electrically insulative layer 140 inside a metal casing 141 covering the coil 138. In the illustrated embodiments, the coil 138 may be made from any electrically conductive material. In some embodiments, the layer 140 may be a Kapton plastic while the metal casing 141 can be non-magnetic stainless steel. In other embodiments, the layer 140 may be made from other materials. In one implementation, the magnets 50, 52 can have AWG 18 varnish insulated copper magnet wire windings sealed with a Kapton plastic tape insulator inside a positively charged and grounded non-magnetic 310 or 316 stainless steel casing with tubular passages (not shown) for coolant flow. During use, the conductor 58 is electrically coupled to a current source (not shown) for supplying a current to each of the magnetic mirrors 50, 52. The configuration of the magnet 50/52 shown in the figure makes the magnet 50/52 appear positively charged to the ions. Also, as shown in the figure, the current flow in the same direction for both magnets 50, 52, thereby creating the magnetic fields shown. As a result, the ions will travel in the ion path illustrated in the figure. Although only one magnetic field line is shown for each of the magnets 50, 52, it should be understood that the magnetic field for each magnet 50, 52 occurs along the entire perimeter of the ring.

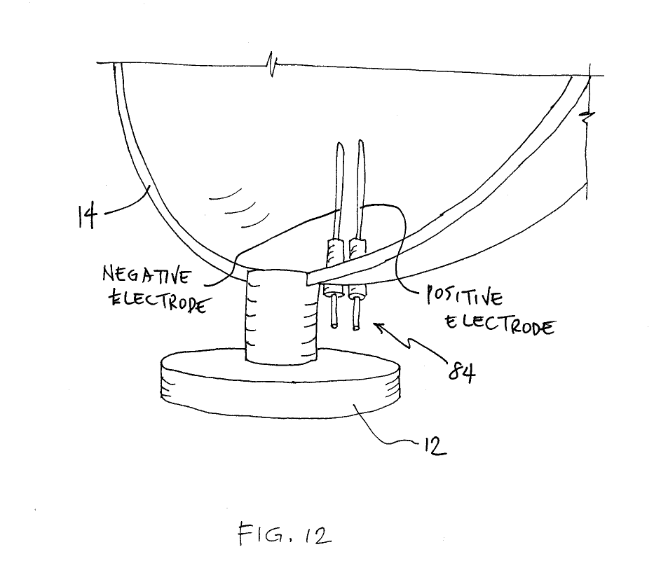

FIG. 12 illustrates the ionizer 84 in accordance with some embodiments. The ionizer 84 may be used with the system of FIG. 1 as well. The ionizer 84 includes a positive electrode and a negative electrode (e.g. 200 to 600 volts). During use, electrons jump between the ionizer's two electrodes converting the deuterium gas into ions. These ions then accelerate and rotate around the negative cage 16 due to the magnetic mirrors 50, 52 and the positive cage 16 configuration. In some embodiments, the ionizer 84 may be located at the perimeter of the gas swirl caused by ion rotation. In some embodiments, the ionizer 84 is not required if the negative cage's rotating electron cloud (i.e., the electrons at the negatively charged electrodes 30, 32) can convert enough deuterium to ions.

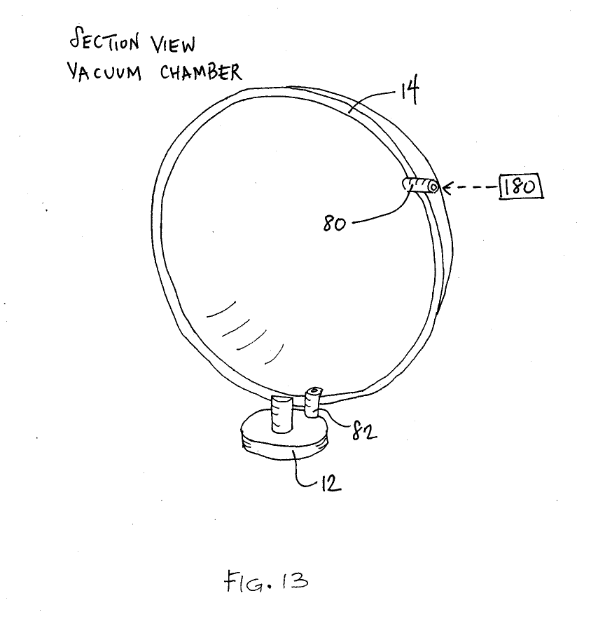

FIG. 13 illustrates the gas transport components of the system 10 in accordance with some embodiments. The gas transport components may be used with the system 10 of FIG. 1 as well. As shown in the figure, the gas in-port 80 is located at a higher elevation compared to the gas out-port 82. This may be advantageous in some embodiments especially when the byproducts of the fusion include heavier gas. In other embodiments, the gas in-port 80 and the gas out-port 82 may be located in other locations at the vacuum chamber 14. During use, the gas in-port 80 is in fluid communication with a gas supply 180, and the gas out-port 82 is in fluid communication with a container for collecting by-products resulted from nuclear fusion that occurs inside the vacuum chamber 14. In some embodiments, the vacuum chamber 14 may be a non-magnetic 310 or 316 stainless steel vacuum chamber that is positively charged and electrically grounded during use with vacuum pressure (e.g., less than 7 miilitorrs (or microns of Hg)) applied there-within.

In the illustrated embodiments, the gas supply 180 together with the ionizer 84 form an ion source for providing ions at the space 40 in the cage 16 during use. In the illustrated embodiments, the ion source is configured to provide deuterium as ions. In other embodiments, the ion source may be configured to provide tritium, other ions, or combination thereof. In some embodiments, the ion source is configured to provide any particles with nuclei having any mass, such as one that is lower than iron. As used in this specification, the term “ion source” may be any device that is configured to generate and/or deliver particles having a charge (e.g., a positive charge or a negative charge). In other embodiments, the gas in-port itself may be considered an ion source. In other embodiments, the system 10 may further include additional in-port(s) for delivering additional ions into the space 40 during use. For example, in some embodiments, the system 10 may include two in-ports on opposite sides of the vacuum chamber 14. The two in-ports may be coupled to a same gas source, or different respective gas sources. In some cases, the first and second ion sources may deliver the same type of ions, such as deuterium. In other embodiments, the first and second ion sources may deliver different types of ions. For example, one ion source may deliver deuterium, while the ion source delivers tritium.

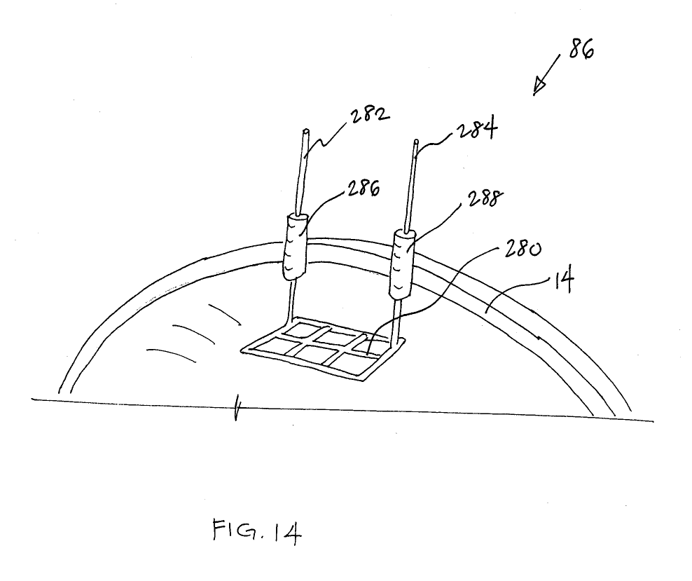

FIG. 14 illustrates the energy collection component 86 of the system 10 in accordance with some embodiments. The energy collection component 86 may be used with the embodiments of FIG. 1 as well. As shown in the figure, the energy collection device 86 includes a grid 280 coupled to two terminals 282, 284. The terminals 282, 284 are housed in respective insulators 286, 288 and extend through the vacuum chamber 14. Although only a small section of the grid 280 is shown, it should be understood that in some embodiments, the grid 280 may extend throughout the interior of the vacuum chamber 14. For example, in some embodiments, the grid 280 may have a spherical configuration, and extend along and near the interior surface of the vacuum chamber 14 between the vacuum chamber 14 and the cage 16. The electrical grid 86 is configured to capture energy released from a fusion process that occurs within the space 40 of the cage 16. In some embodiments, the electrical grid 280 may be coupled to the elements 26 and/or 28 of the cage 16. For example, posts may be provided that separate the cage elements 26 and/or 28 and the grid 280, in which case, the grid 280 is coupled to the cage elements via the posts.

During use of the system 10, suction is created within the grounded vacuum chamber 14 that houses the cage 16, the magnetic mirrors 50, 52, and the electrical grid 280. The electrical grid 280 for collecting energy is positively charged (e.g. 10 to 20 kv, the same as cage 16), and the cage elements 26, 28 of the cage 16 are also positively charged (e.g. 10 to 20 kv) and grounded. The two electrodes 30, 32 within the cage 16 are negatively charged (e.g. 10 to 20 kv). The ion source 80 then injects gas into the vacuum chamber 14. The ionizer 84 applies a potential (e.g. 200 to 600 volts) between its terminals to create ions within the chamber 14.

In the illustrated embodiments, the charged cage 16 and the charged electrode cages 30, 32 are used to increase ion velocity, provide ion confinement, and increase ion density, thereby focusing ion collisions to provide an ideal condition for nuclear fusion. The magnetic mirrors 50, 52 use Lorentz' right-hand rule to induce high velocity ion and electron rotation, while confining the ions within the space 40 defined by the cage elements 26, 28. Fluctuating ripple voltages are provided to the cage elements 26, 28 and electrodes 30, 32 to thereby accelerate the ions. In some embodiments, the voltage source is configured to provide a current that fluctuates in a periodic manner (e.g., in a sinusoidal manner) between a high level (e.g., 20 kv) and a low level (e.g., 10 kv) at a certain prescribed frequency, such as 3.9 MHz. The voltage signal to magnetic mirrors 50 and 52 are preferred to be a steady state DC signal (or it could be a fluctuating DC ripple voltage) to control the rate of fusion. During high flux densities, the ions would have a smaller radius of rotation and therefore less likelihood of collisions. When the flux density lowers, the collision rate increases. In other embodiments, the energy levels may be different, and the frequency may be different from that described. The energy levels and the frequency may be selected to obtain resonance to thereby accelerate ions that are in the space 40.

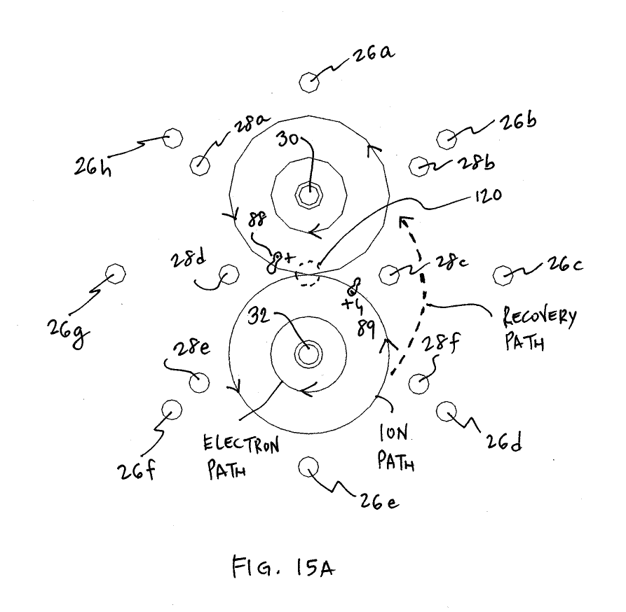

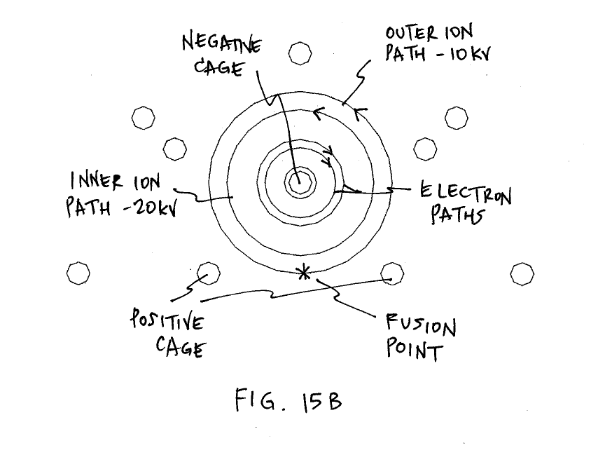

As shown FIG. 15A, due to the configuration of the cage 16, the positively charged cage 16, the negatively charged nodes 30, 32, and the magnetic mirrors 50, 52, an ion path is created that has a figure 8 shape, where the intersection is the point of fusion (e.g., region 120). In particular, the two identical electromagnets 50, 52 create magnetic lines of force between them to induce ions into a circular path, resulting in confinement and rotational motion of the ions about the nodes 30, 32. The ions between the electrode 30 and the members 26a, 28a, 28b, 28c, and 28d will travel in an ion path 300a, which circumscribes the negatively charged electrode 30. The positively charged members 26 and 28 around the electrode 30 assist in confining the ions within the space 40 while the ions are accelerated along the path 300a. While the positively charged ions travel around the electrode 30 in one direction, electrons at the electrode 30 travel along a path (e.g., around the cage of the electrode 30) that is in the opposite direction, creating a virtual cathode that limits electron emissions from the negative cage 30. The separate rotation radii, opposing directions and high velocities prevent the two charges from combining, but their attractions aid in mutual confinement. In some cases, the electron rotation prevents collisions with the positively charged cage 16, thereby preventing losses so that energy is saved.

Similarly, ions between the electrode 32 and the members 26e, 28c, 28d, 28e, and 28f will travel in an ion path 300b, which circumscribes the negatively charged electrode 32. The positively charged members 26 and 28 around the electrode 32 assist in confining the ions within the space 40 while the ions are accelerated along the path 300b. While the positively charged ions travel around the node 32 in one direction, electrons at the node 30 travel along a path (e.g., around the cage of the node 32) that is in the opposite direction, creating a virtual cathode that limits electron emissions from the negative cage 32. The separate rotation radii, opposing directions and high velocities prevent the two charges from combining, but their attractions aid in mutual confinement. In some cases, the electron rotation prevents collisions with the positively charged cage 16, thereby preventing losses so that energy is saved. In FIG. 15A the DC ripple negative signal to electrodes 30 and 32 may fluctuate at the same frequency, amplitude and synchronization so that the resulting ion waves will resonate and not cancel each other out when they meet at the point of fusion 120 thereby preventing loss of velocity and energy. In FIG. 15A the ions at the point of fusion 120 may mainly meet with their individual concentrations of positive charge pointing inward toward their respective negative electrodes (e.g. ion 88 toward electrode 30 and ion 89 toward electrode 32) minimizing the Coulomb barrier due to having like positive charge ends away from each other when the ions 88 and 89 collide. In the case of deuterium ions 88, 89 the positive proton may mainly point toward the negative electrode and the neutron away from it.

The two ion paths 300a, 300b collectively form a figure-8 shape ion path. In some cases, ions may escape from within the space 40. In such cases, the outer members 26a-26h will assist in confining the escaped ions, and push the ions back to the ion path 300a/300b, as illustrated by the arrows that correspond to “recovery path.”

In other embodiments, the outer cage members 26b, 26c, 26d, 26f, 26g, 26h, are not needed. In such cases, the ion path 300a may be created using the members 26a, 28a-28d and the ion path 300b may be created using the members 26e, 28c-28f. In some embodiments, if the outer cage members 26b, 26c, 26d, 26f, 26g, 26h are not included, the walls of the vacuum chamber 14 may be made smaller, so that the space defined by the vacuum chamber walls is the same as, or slightly bigger (e.g., 10% or less bigger) than, the space defined by the outer cage members 26a-26h (in the embodiments in which the outer cage members 26a-26h are used).

When two particles collide within the space 40, fusion occurs and energy is released. In the illustrated embodiments, the electrical grid 280 is positively charged during use, and is used to capture the energy released from the fusion process. Devices and techniques for capturing energy released from fusion process are known in the art, and will not be described in further detail. In some embodiments, high energy ions in the space 40 will transfer their kinetic energy (due to the ions' velocity) to potential energy upon fusion, which potential energy is converted into electrical current with a 95% efficiency. In some cases, the system 10 may further include a vacuum pump (not shown) for removing gas that is resulted from the fusion process in the cage 16 (e.g., after the energy has been absorbed by the positive grid 280).

FIG. 15B illustrates ion path fluctuation due to the cage 16's DC voltage fluctuation. Analyzing the top half of the cage, when the ion moves from a higher to lower path due to the cage's dc voltage fluctuations, the potential energy (distance from center) decreases but the kinetic energy (speed) increases due to the inward pull. When the ion moves from lower to higher path the potential energy increases again but the kinetic energy does not decrease much because the inward force is less. The speed increases with each cycle causing the ion to spiral outward. Thus, as the DC voltage supplied to the cage 16 fluctuates, the ion path will also fluctuate within the space 40 accordingly. The electron will also accelerate when shifting from a higher to lower path but at a slower rate and is slowed down by the ion's counter-rotation.

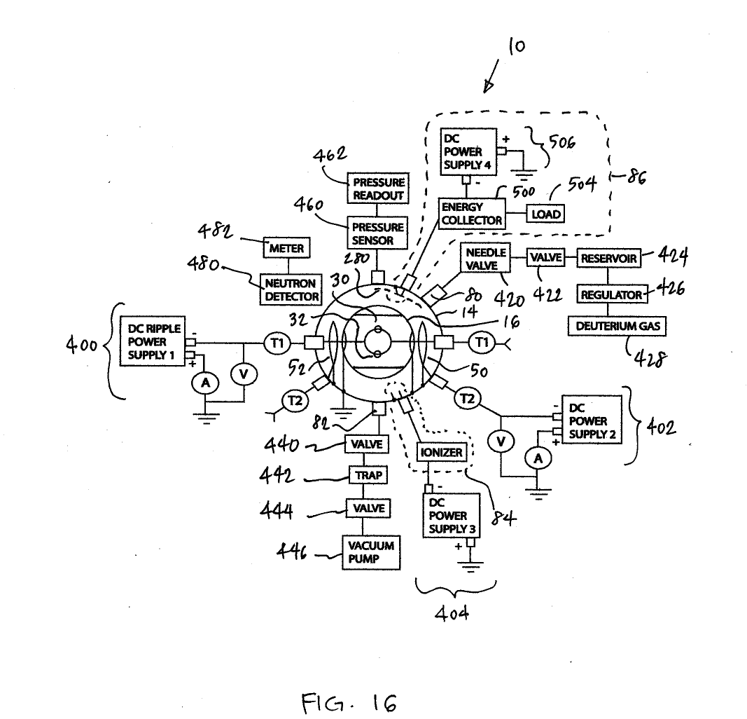

FIG. 16 illustrates a block diagram of the system 10 that is coupled to the various components during use. In some embodiments, the components coupled to the system 10 may be considered to be parts of the system 10. The coolant system is not shown for clarity. As shown in the figure, the system 10 includes a first DC power supply system 400 for supplying voltage to the cage 16 and the electrodes 30, 32, a second DC power supply system 402 for supplying voltage to the magnetic mirrors 50, 52, and a third DC power supply system 404 for supplying voltage to the ionizer 84. The gas in-port 80 is coupled to a needle valve 420, a valve 422, a reservoir 424, a regulator 426, and a supply 428 of deuterium gas. The needle valve 420 finely regulates the amount of deuterium fed into the vacuum chamber 14. The valve 422 roughly regulates the amount of deuterium fed into the needle valve 420. The reservoir 424 can be a coiled tube to allow the deuterium to accumulate and stabilize the pressure. In some embodiments, the regulator 426 may be configured to lower the deuterium bottle 428 gas pressure e.g. from 800 to 1000 psi to 5 to 10 psi. The gas out-port 82 is coupled to a valve 440, a trap 442, another valve 444, and a vacuum pump 446. The valves 440 and 444 are configured to isolate parts of the vacuum line, allow the user to lower the line pressure in stages, and to detect any leaks in the system. The coax trap 442 is used for trapping vacuum pump 446 hydrocarbons from backstreaming into a vacuum system. The system 10 also includes a pressure sensor 460 for sensing a pressure within the chamber 14, and a pressure readout 462 for informing user of the pressure within the chamber 14. The system 10 also includes a neutron detector 480 and a meter 482. The neutron detector 480 may include a tube filled with Boron Trifluoride (BF3) covered with 4 inches of wax, which is connected to the meter 482. When a neutron enters the tube, it induces a reaction in the BF3 fill gas, thereby creating an electrical pulse, which then registers on the meter 482. The energy collection grid 280 is coupled to an energy collector 500, a load 504, and a fourth DC power supply 506. The energy collector's grid 280 is positively biased by the DC power supply 506. The grid 280 slows down any fast positive ions produced after fusion that passes through, and coverts their kinetic energy into an electrical pulse that is smoothened out by the energy collector 500 circuit. Thus, the grid 280 and the energy collector 500 functions as a power supply for the load 504 which can be a battery or any other electrical energy storage system.

Embodiments of the system 10 described herein provide particle velocity, particle cloud density, and confinement time sufficient to produce enough reactions to generate power. In the above embodiments, the generated power resulted from fusion is designed to be higher than the power required to drive the reaction. The fusion rate per unit volume FR is governed by the equation: FR=n1n2σv, where n1 and n2 are the densities of two colliding particles, σ is the fusion cross-section at the velocity or particle energy, and v is the particle velocity relative to the other particle. The σ is also known as a reaction cross section, which is a measure of the probability of a fusion reaction as a function of the relative velocity of the two colliding particles. In the system 10 design, the ion densities (n1 and n2) are increased by the focused head-on ion collisions and recirculation if the ions miss. The velocity (v and also σ) is increased by the dual-electrode fluctuations that are in resonance to each other so that there is minimal loss of speed and therefore more energy for recirculation should the ions miss collision.

During the above described fusion process, the system 10 is cooled using a cooling system. In the illustrated embodiments, the cage 16 may include passage ways within the elements 26, 28, wherein the passage ways may be in fluid communication with a fluid source. During use, the fluid source delivers liquid coolant into the passage ways within the elements 26, 28 of the cage 16, thereby providing a cooling effect for the cage 16. Other components, such as the cage elements for the nodes 30, 32, may also be cooled in a similar fashion.

As illustrated in the above embodiments, the system 10 is advantageous over existing fusion systems in that it does not require accelerating electrons to merge with ions within space 40 at which fusion occurs. Also, embodiments of the system 10 are advantageous in that they address all of the fusion requirements. In particular, the system 10 described above provides (1) sufficient particle velocity for nuclear fusion (because the cage 16's fluctuating high voltage potential difference creates the rotational ion velocity for optimal head-on collision), (2) sufficient particle density for nuclear fusion (because the ions follow a tight rotational path that increases its concentration and then merge into a single point of collision), and (3) sufficient particle confinement for nuclear fusion (because the magnetic mirrors/solenoids 50, 52, positive confinement cage 16, and the negative nodes 30, 32 limit ions to a figure-8 shaped path). In addition, the system 10 is advantageous because the use of two magnetic mirrors/solenoids 50, 52 assists in creating the two ion paths 300a, 300b that collectively form the figure-8 configuration, thereby promoting ion confinement and ion collisions. In addition the DC ripple negative signal to electrodes 30 and 32 may fluctuate at the same frequency, amplitude and synchronization so that the resulting ion waves will resonate and not cancel each other out when they meet at the point of fusion 120 thereby preventing loss of velocity and energy. Also the ions at the point of fusion 120 may mainly meet with their individual concentrations of positive charge pointing inward toward their respective negative electrodes (e.g. ion 88 toward electrode 30 and ion 89 toward electrode 32) minimizing the Coulomb barrier due to having like positive charge ends away from each other when the ions collide. In the case of deuterium ions 88, 89 the positive proton may mainly point toward the negative electrode and the neutron away from it.

Furthermore, the system 10 is advantageous because ion loss is prevented or at least reduced by rotation of the ions away from the negative electrode (which prevents energy losses due to collisions with the negative electrode cages 30, 32). Also, electron loss is prevented or at least reduced by rotation of the electrons away from the positive electrode, which prevents losses by contact with the positive cage 16 and Bremsstrahlung radiation. In addition, because the electrodes 30, 32 are small compared to the cage 16, Paschen discharge between the electrodes 30, 32 and the cage 16 is significantly reduced or minimized. In some cases, the cage 16, the magnetic mirrors/solenoids 50, 52, and the chamber charge layers are configured for minimal Paschen discharge loss.

It should be noted that the system 10 is not limited to the embodiments described previously, and that the system 10 may have different configurations in different embodiments. For example, in other embodiments, the cage 16 of the system 10 may have different shapes. Also, in other embodiments, the components within the vacuum chamber 14 may be supported in different ways.

In any of the embodiments described herein the ion path is not limited to have a figure 8 shape. In other embodiments, the ion path may have other shapes, such as a circular shape, an elliptical shape, or other shapes, depending on the manner in which the cage 16 is configured. Regardless of how the cage 16 is configured, the magnetic mirrors 50, 52 will assist confinement of at least some of the ions in the space 40, will improve the density of the particle cloud, and will promote ion collisions within the space 40.

Furthermore, in other embodiments, the system 10 may not include all of the components described herein. For example, in other embodiments, the system 10 may not include some of the cage members 26 and/or 28.

The following section illustrates some of the calculation that may be used in the design of the system 10. The values in the calculation are examples only. It should be noted that in different embodiments, the values may be different. Also, in other embodiments, equations different from the ones presented herein may be used instead. In further embodiments, the assumptions made in the following calculation may be different.

The magnetic mirror field strength can be calculated as follow: Assuming a 4 cm radius of 8-shaped rotation and a 4 cm diameter winding core the magnetic mirror field strength is derived from the formulas:

N=(D1̂2/D2̂2)×U

B=8.99exp−7×u×N×I/R

Where: N=1440 (number of wire turns, answer), D1=4 cm (diameter of core), D2=0.10 cm (diameter of wire AWG18), U=0.90 (approximate winding utilization factor), B=magnetic field, u=relative permeability, vacuum=1 (note: iron>1), I=rated current 16 amps, and R=2*r=0.08 m (radius of the windings also the gap between the two ring electromagnets). Using the above equation, B is calculated as 0.259 tesla (magnetic field strength) in accordance with some embodiments.

The ion velocity may be calculated as follows: Assuming deuterium fuel, the formula for determining the velocity of deuterium to achieve fusion is v=(2*E/m)̂0.50, where: E=0.01 MeV (minimum energy barrier for fusion) or 1.6 exp −15 joules, m=mass of deuterium or 2*1.67 exp −27 kg. This makes v=9.8 exp 5 m/sec in accordance with some embodiments, or 0.33% the speed of light (3 exp 8 m/sec).

The ion rotation frequency may be calculated as follow: The formula for determining the rotation frequency of the ion is w=v/(2*3.1416*r), where: w=rotation frequency, rotation/sec or hertz, v=velocity of the ion, m/sec, r=radius of rotation in meters. This makes w=3.9 exp 6 Hz or 3.9 MHz in accordance with some embodiments, which is the resonant ripple frequency of the electrodes for maximum speed amplification. However this frequency needs to adjust in direct proportion to the square root of ion density. A lower frequency may be used to slow down the rate of fusion and to increase the odds of collision. In some cases, tuning may be performed to obtain the desired rate of fusion.

The ion's radius of rotation achieved using only the magnetic mirror may be calculated as follow. The formula for determining Deuterium's radius of rotation via magnetic mirror is r=my/qB, where: m=2*1.67 exp −27 kg (mass of a proton and neutron), v=9.8 exp 5 m/sec (ion velocity for fusion), q=1.6 exp −19 coulomb (charge of a proton), B=0.259 tesla (magnetic mirror field strength). Using the above equation, r is calculated as 0.079 m or 8 cm (radius of rotation by the magnetic mirror only) in accordance with some embodiments. When active cage electrodes are used, the radius would be less.

The voltage between positive and negative electrodes may be calculated using the equation: V=(m*v̂2)/(2*q), where: V=voltage between electrodes, volts, m=2*1.67 exp −27 kg (mass of deuterium), v=9.8 exp 5 (velocity for fusion), q=1.6 exp −19 (charge of a proton). Using the above equation, V is calculated as 10 kv (minimum dc voltage) in accordance with some embodiments.

The formula for determining the inward total force on the ion may be calculated using the following equations:

Ft=Fm+Fg

Ft=q*v*B+E*q

Where: Ft=total force in kg, Fm=force due to the magnetic mirror, Fg=force due to the electrodes, q=1.6 exp −19 coulomb (charge of a proton), v=9.8 exp m/sec (velocity for fusion), B=0.259 tesla (magnetic field strength), and E=V/r=10,000 volts/0.04 m=2.5 exp 5 (electric field). Using the above equation, Ft may be calculated as 8.06 exp −14 kg in accordance with some embodiments.

The formula for determining the deuterium ion's radius of rotation is r=(m*v̂2)/Ft, where: r=ion's radius of rotation, m=2*1.67 exp −27 kg (mass of deuterium), v=9.8 exp 5 m/sec (velocity for fusion), and Ft=8.06 exp −14 total magnetic and electrostatic force. Using the above equation, r may be calculated as 0.04 m or 4 cm in accordance with some embodiments. In some embodiments, this may be considered to be the maximum radius, and the system 10 may be designed to confine the ions within the cage 16 with active magnetic mirrors 50, 52 and electrodes 30, 32).

Combining the prior formulas the overall equation for determining the deuterium ion's radius of rotation is: Rv=(2*r*m*v̂2)/(q*(v*8.99 exp −7*N*I+2*V)), where: Rv=ions radius of rotation variable, r=maximum ion radius of rotation, constant, m=2*1.67 exp −27 kg (mass of deuterium, neutron+proton), q=1.6 exp −19 (charge of a proton), v=9.8 exp 5 m/sec (velocity for fusion), N=1440 (number of winding turns per magnetic mirror), I=16 amps (current for the magnetic mirror), and V=10,000 volts (voltage of the electrode cages) or 20,000 volts. Using the above equation, Rv may be calculated as 0.04 m or 4 cm (which may be considered the maximum radius at V=10 kv), and Rv may be calculated as 0.027 m or 2.7 cm (which may be considered the lower radius at V=20 kv). These values are calculated assuming a dc ripple of 10 kv to 20 kv.

Although particular embodiments have been shown and described, it will be understood that they are not intended to limit the present inventions, and it will be obvious to those skilled in the art that various changes and modifications may be made without departing from the spirit and scope of the present inventions. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. An apparatus for generating power, comprising:
a cage having a plurality of elongated elements defining a space within the cage, wherein the space has a region for allowing ion collision to occur; and
a pair of electromagnets located at or near respective opposite ends of the cage.

2. The apparatus of claim 1, wherein the pair of electromagnets comprises a first solenoid and a second solenoid.

3. The apparatus of claim 2, wherein each of the first and second solenoids has an inner core with a cross section that resembles a dumbbell shape, and an outer core, the inner core having a relatively lower electromagnetic permeability than the outer core.

4. The apparatus of claim 2, further comprising a coupler that mechanically couples the first solenoid to the second solenoid.

5. The apparatus of claim 4, wherein the coupler has an end defining an opening that resembles a dumbbell shape.

6. The apparatus of claim 1, wherein one of the electromagnets includes a ring that circumscribes a part of the cage.

7. The apparatus of claim 1, wherein the pair of electromagnets are identical, and face towards each other to form a pair of magnetic mirrors.

8. The apparatus of claim 1, further comprising a first electrode and a second electrode located inside the cage.

9. The apparatus of claim 8, wherein each of the first and second electrodes has a cage configuration.

10. The apparatus of claim 8, wherein the first and second electrodes are configured to be negatively charged, and the cage is configured to be positively charged.

11. The apparatus of claim 8, wherein the first and second electrodes, the pair of electromagnets, and the cage cooperate with each other to move ions inside the cage in a figure-8 path.

12. The apparatus of claim 8, wherein the cage includes two rings at the respective opposite ends of the cage, and the first and second electrodes are supported on a support with support ends that extend through the respective rings of the cage.

13. The apparatus of claim 1, wherein the elongated elements extend between the opposite ends of the cage.

14. The apparatus of claim 1, wherein the elongated elements comprises a first set of members and a second set of members, wherein the second set of members are located radially further away from a center of the cage than the first set of members.

15. The apparatus of claim 1, wherein the space defined by elongated elements of the cage has a dumbbell shape at a cross section of the cage.

16. The apparatus of claim 1, further comprising a cooling system for cooling the cage.

17. The apparatus of claim 1, further comprising an energy collector for collecting energy resulted from the ion collision.

18. An apparatus for generating power, comprising:
a cage having opposite ends and at least six elongated elements extending between the opposite ends, the at least six elongated elements defining a space within the cage, wherein the space has a first region for allowing ions to move in a first circular path, and a second region for allowing additional ions to move in a second circular path.

19. The apparatus of claim 18, further comprising a first electrode and a second electrode located inside the cage.

20. The apparatus of claim 19, wherein each of the first and second electrodes has a cage configuration.

21. The apparatus of claim 20, further comprising a pair of electromagnets, wherein the first and second electrodes, the pair of electromagnets, and the cage cooperate with each other to move the ions inside the cage in the first and second circular paths.

22. The apparatus of claim 21, further comprising a coupler that mechanically couples the pair of electromagnets, wherein the coupler is configured to direct magnetic field through the cage.

23. An apparatus for generating power, comprising:
a vacuum chamber;
a first solenoid;
a second solenoid, wherein the first and the second solenoids are located on opposite sides of the vacuum chamber; and
a coupler that mechanically couples the first solenoid to the second solenoid;
wherein the coupler has an end defining an opening that resembles a dumbbell shape.

24. The apparatus of claim 23, further comprising a cage within the vacuum chamber.

25. The apparatus of claim 24, wherein the cage defines a space that resembles a dumbbell shape.

26. The apparatus of claim 24, further comprising two electrodes located within the cage.
